(19) United States
(12) Patent Application Publication
(10) Pub. No.: US 2026/0019514 A1
(43) Pub. Date: Jan. 15, 2026

(54) IMAGE READING APPARATUS AND IMAGE FORMING APPARATUS

(71) Applicant: CANON KABUSHIKI KAISHA, Tokyo (JP)

(72) Inventor: TAKATSUGU NAKAMURA, Saitama (JP)

(21) Appl. No.: 19/227,343

(22) Filed: Jun. 3, 2025

(30) Foreign Application Priority Data
Jul. 9, 2024 (JP) 2024-110380

(51) Int. Cl. H04N 1/00; G03G 15/22

(52) U.S. Cl. CPC H04N 1/00615; G03G 15/228; H04N 1/00602; H04N 1/00814; H04N 1/00824; H04N 2201/0081

(57) ABSTRACT

Disclosed is an image reading apparatus includes a document reading apparatus; a document feeder; and a controller. The document reading apparatus is provided with a transparent member and an image reading portion configured to read an image on a document conveyed by the document feeder via the transparent member. The document feeder is provided with a conveying roller configured to convey the document and a guide member configured to guide the document conveyed by the conveying roller, the guide member being opposed to the transparent member. The guide member is provided with a discriminating portion corresponding to a type of the document feeder. The controller identifies the type of the document feeder based on a result of the image reading portion reading a region including the discriminating portion of the guide member.

### BACKGROUND

### Field of the Technology

This disclosure relates to an image reading apparatus which is constituted by the combination of a document reading apparatus and a document feeder and to an image forming apparatus with this image reading apparatus.

### Description of the Related Art

Conventionally known is an image forming apparatus which is provided with an image forming apparatus main body for forming an image on a sheet and an image reading apparatus for reading an image of a document. In such an image forming apparatus, it is required that the combination of the image forming apparatus main body and the image reading apparatus mounted on it is appropriate. The Japanese Patent Application Laid-open No. 2001-127933 discloses an image forming apparatus having an identification circuit for identifying the combination of the image forming apparatus main body and the image reading apparatus.

On the other hand, an image reading apparatus is known on which a document feeder that conveys a document on a document reading apparatus that reads an image on the document is mounted. In the image reading apparatus, it is desired for the document reading apparatus to perform a reading control according to the specification of the document feeder.

However, in the conventional configuration, the document reading apparatus cannot identify a type of the document feeder.

### SUMMARY

Therefore, the present disclosure is directed to providing an image reading apparatus and image forming apparatus that are capable of identify a type of a document feeder.

An image reading apparatus according to the present disclosure comprising:
a document reading apparatus;
a document feeder; and
a controller,
wherein the document reading apparatus is provided with a transparent member and an image reading portion configured to read an image on a document conveyed by the document feeder via the transparent member,
wherein the document feeder is provided with a conveying roller configured to convey the document and a guide member configured to guide the document conveyed by the conveying roller, the guide member being opposed to the transparent member,
wherein the guide member is provided with a discriminating portion corresponding to a type of the document feeder, and
wherein the controller identifies the type of the document feeder based on a result of the image reading portion reading a region including the discriminating portion of the guide member.

Further features of the present disclosure will become apparent from the following description of embodiments with reference to the attached drawings. The following description of embodiments are described by way of example.

### BRIEF DESCRIPTION OF THE DRAWINGS

FIG. 1 is a schematic diagram of an image forming apparatus according to a first embodiment of the present disclosure.

FIG. 2 is a diagram showing a perspective view of an image reading apparatus according to the first embodiment of the present disclosure.

FIG. 3 is a schematic diagram of the image reading apparatus according to the first embodiment of the present disclosure.

FIGS. 4A and 4B are a diagram showing the configuration of a platen guide of the image reading apparatus according to the first embodiment of the present disclosure.

FIGS. 5A, 5B and 5C are graphs showing examples of changes in brightness of a signal read by the the image reading apparatus the image reading apparatus according to the first embodiment of the present disclosure.

FIGS. 6A and 6B are schematic diagrams showing a platen guide of the image reading apparatus according to the second embodiment of the present disclosure.

### DESCRIPTION OF THE EMBODIMENTS

In the following, the embodiments of the present disclosure will be described with reference to the figures.

### First Embodiment

### Configuration of Image Forming Apparatus

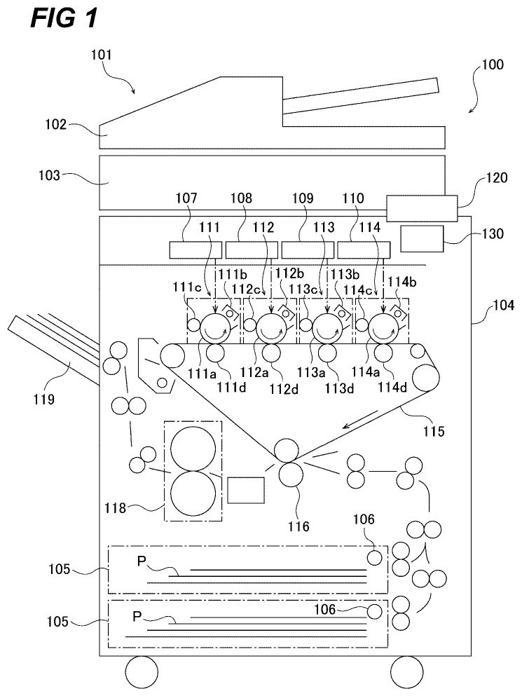

The configuration of the image forming apparatus 100 according to the first embodiment of the present disclosure will be described with reference to FIG. 1.

The image forming apparatus 100 includes the image reading apparatus 101, the apparatus main body 104, the sheet feeding cassette 105, the sheet feeding roller 106, the laser scanners 107 to 110, the image forming units 111 to 114, the intermediate transfer belt 115, the secondary transfer roller 116, the fixing unit 118, the discharge tray 119 and the operation portion 120.

The laser scanners 107 to 110 and the image forming units 111 to 114 constitute an image forming portion.

The image reading apparatus 101 is provided above the apparatus main body 104. The ADF (Automatic Document Feeder) 102 is combined with the document reading apparatus 103 to constitute the image reading apparatus 101. The image reading apparatus 101 reads the image on the document D. The detailed configuration of the image reading apparatus 101 will be described later.

The apparatus main body 104 stores various members and devices for forming an image on a sheet P as a recording material.

The sheet feeding cassette 105 stacks and accommodates the sheets P.

The sheet feeding roller 106 feeds the sheets P accommodated in the sheet feeding cassette 105 towards the secondary transfer roller 116.

The laser scanner 107 forms an electrostatic latent image on the photosensitive drum by irradiating with laser the photosensitive drum 111a of the image forming unit 111 based on image information on yellow Y out of image information of the image read by the image reading apparatus 101.

The laser scanner 108 forms an electrostatic latent image the photosensitive drum by irradiating with laser the photosensitive drum of the image forming unit 111 based on image information on magenta M out of image information of the image read by the image reading apparatus 101.

The laser scanner 109 forms an electrostatic latent image the photosensitive drum by irradiating with laser the photosensitive drum of the image forming unit 111 based on image information on cyan C out of image information of the image read by the image reading apparatus 101.

The laser scanner 110 forms an electrostatic latent image the photosensitive drum by irradiating with laser the photosensitive drum of the image forming unit 111 based on image information on black K out of image information of the image read by the image reading apparatus 101.

The image forming unit 111 forms a toner image of yellow Y and primarily transfers the formed toner image of yellow Y onto the intermediate transfer belt 115. The image forming unit 111 is provided with the photosensitive drum 111a, the charging device 111b, the developing device 111c, and the primary transfer roller 111d. The photosensitive drum 111a rotates in the direction of the arrow in FIG. 1. On the photosensitive drum 111a uniformly charged by the charging device 111b, an electrostatic latent image is formed by the laser scanner 107.

The charging device 111b uniformly charges the surface of the photosensitive drum 111a.

The developing device 111c forms the toner image of yellow Y on the photosensitive drum 111a by supplying toner to an electrostatic latent image formed on the photosensitive 111a by the laser scanner 107.

The primary transfer roller 111d primarily transfers the toner image formed on the photosensitive e drum 111a by the developing device 111c onto the intermediate transfer belt 115.

The image forming unit 112 forms a toner image of magenta M and primarily transfers the formed toner image of magenta M onto the intermediate transfer belt 115. The image forming unit 112 is provided with the photosensitive drum 112a, the charging device 112b, the developing device 112c, and the primary transfer roller 112d. Since the configurations of the photosensitive drum 112a, the developing device 112c, and the primary transfer roller 112d are the same as those of the photosensitive drum 111a, the developing device 111c, and the primary transfer roller 111d except that the toner image of magenta M is formed and primarily transferred, description thereof is omitted. Further, since the configuration of the charging device 112b is the same as that of charging device 111b, the description thereof is omitted.

The image forming unit 113 forms a toner image of cyan C and primarily transfers the formed toner image of cyan C onto the intermediate transfer belt 115. The image forming unit 113 is provided with the photosensitive drum 113a, the charging device 113b, the developing device 113c, and the primary transfer roller 113d. Since the configurations of the photosensitive drum 113a, the developing device 113c, and the primary transfer roller 113d are the same as those of the photosensitive drum 111a, the developing device 111c, and the primary transfer roller 111d except that the toner image of cyan C is formed and primarily transferred, description thereof is omitted. Further, since the configuration of the charging device 113b is the same as that of charging device 111b, the description thereof is omitted.

The image forming unit 114 forms a toner image of black K and primarily transfers the formed toner image of black K onto the intermediate transfer belt 115. The image forming unit 114 is provided with the photosensitive drum 114a, the charging device 114b, the developing device 114c, and the primary transfer roller 114d. Since the configurations of the photosensitive drum 114a, the developing device 114c, and the primary transfer roller 114d are the same as those of the photosensitive drum 111a, the developing device 111c, and the primary transfer roller 111d except that the toner image of black K is formed and primarily transferred, description thereof is omitted. Further, since the configuration of the charging device 114b is the same as that of charging device 111b, the description thereof is omitted.

Onto the intermediate transfer belt 115, toner images are primarily transferred by the image forming units 111 to 114. The intermediate transfer belt 115 rotates in the direction of the arrow in FIG. 1 to convey the primarily transferred toner images.

The secondary transfer roller 116 secondarily transfers the toner image having been transferred onto the intermediate transfer belt 115 onto the sheet P fed by the sheet feeding roller 106. The secondary transfer roller 116 conveys the sheet P on which the toner image has been secondarily transferred to the fixing unit 118.

The fixing unit 118 fixes the toner image having secondarily transferred on the sheet P by the secondary transfer roller 116 by pressurizing and heating the sheet P conveyed by the secondary transfer roller 116. The fixing unit 118 conveys the sheet P on which the toner image has been fixed towards the discharge tray 119.

The sheet P conveyed by the fixing unit 118 is discharged to the discharge tray 119.

The operation portion 120 as a notifying portion is a touch panel, for example. A user operates the operation portion 120 for inputting information necessary for operating the image forming apparatus 100 and the operation portion 120 outputs an electrical signal according to the operation of the user to the controller 130 (described later) of the image reading apparatus 101.

### Configuration of Image Reading Apparatus

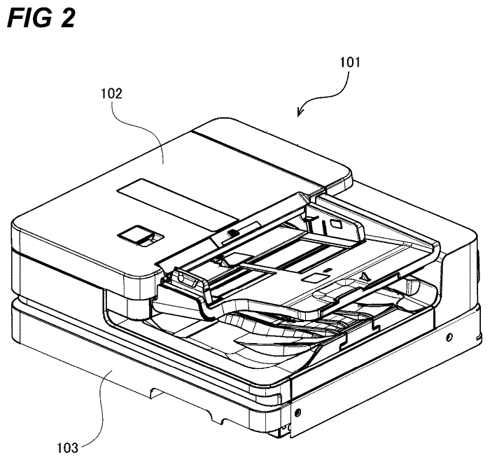

The configuration of the image reading apparatus 101 according to the first embodiment of the present disclosure will be described in detail with reference to FIGS. 2 to 4.

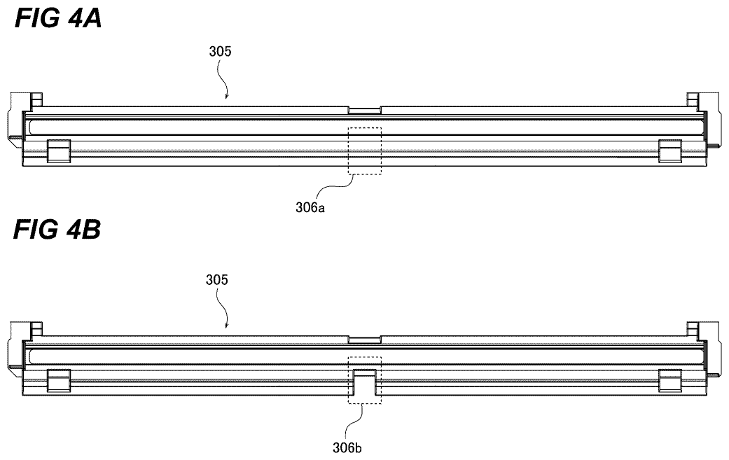

FIG. 4A shows the platen guide 305 of the ADF 102 and FIG. 4B shows another platen guide 305 of an ADF 102 whose type is different from the that of the ADF 102 having the platen guide shown in FIG. 4A.

The image reading apparatus 101 is provided with the ADF 102, the document reading apparatus 103, and the controller 130.

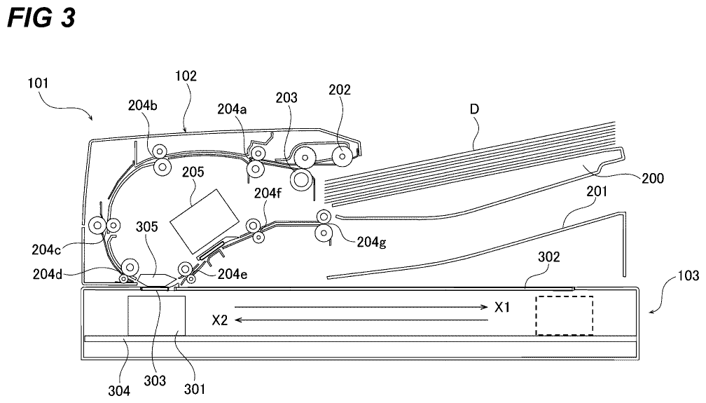

The ADF 102 as a document feeder is provided above the document reading apparatus 103. The ADF 102 is provided on the document reading apparatus 103 such that the ADF 102 is capable of be opened and closed with respect to the document reading apparatus 103. For example, from the state shown in FIG. 3 if the ADF 102 rotates in the counter-clockwise direction, the ADF 102 becomes in the opened state, and then, if the ADF 102 rotates in the clockwise direction, the ADF 102 becomes in the closed state.

The ADF 102 is provided with the document tray 200, the discharge tray 201, the pick-up roller 202, the separating roller 203, the conveying roller pairs 204a, 204b, 204c, 204d, the post conveying roller pairs 204e, 204f, 204g, and the image reading unit 205. The conveying roller pairs 204a, 204b, 204c, and 204d constitutes a conveying portion that is capable of continuously conveying plurality of documents D.

On the document tray 200, the documents D are placed as to be stacked.

On the discharge tray 201, the documents D discharged from the post conveying roller pair 204g are stacked.

The pick-up roller 202 takes in the upper ones of the documents D stacked on the document tray 200.

The separating roller 203 separates the documents D taken in by the pick-up roller 202 one by one and conveys each document D to the conveying roller pair 204a.

The conveying roller pair 204a conveys the document D conveyed by the separating roller 203 to the conveying roller pair 204b.

The conveying roller pair 204b conveys the document D conveyed by the conveying roller pair 204a to the conveying roller pair 204c.

The conveying roller pair 204c conveys the document D conveyed by the conveying roller pair 204b to the conveying roller pair 204d.

The conveying roller pair 204d conveys the document D conveyed by the conveying roller pair 204c to the post conveying roller pair 204e.

The post conveying roller pair 204e conveys the document D conveyed by the conveying roller pair 204d to the post conveying roller pair 204f.

The post conveying roller pair 204f conveys the document D conveyed by the post conveying roller pair 204e to the post conveying roller pair 204g.

The post conveying roller pair 204g discharges the document D conveyed by the post conveying roller pair 204f to the discharge tray 201.

The image reading unit 205 reads an image of each document D conveyed from the document tray 200 to the discharge tray 201. Specifically, the image reading unit 205 irradiates the document D with light emitted from the light source and receives the light reflected from the document D by a reading sensor to read the image on the document D.

The document reading apparatus 103 reads the image of the document D set by a user. The document reading apparatus 103 is provided with the housing 300, the image reading unit 301, the document base glass 302, the flow reading glass 303, the guide shaft 304, and the platen guide 305.

The housing 300 stores the image reading unit 301, the guide shaft 304, and the platen guide 305.

The image reading unit 301 as an image reading portion reads the image on the document D placed on the document base glass 302 by irradiating the document D placed on the document base glass 302 with light while moving in the direction X1 or X2 in FIG. 3. The image reading unit 301 moves along the guide shaft 304 by the moving member such as belt member and a wire (not shown). The image reading unit 301 reads via the flow reading glass 303 the image on each document D conveyed from the document tray 200 of the ADF 102 to the discharge tray 201 in the state where the image reading unit 301 is moved to the image reading position under the flow reading glass 303. The image reading unit 301 outputs the image information of the read image to the controller 130.

The image reading unit 301 irradiates a predetermined region including the discriminating portion 306a or 306b of the platen guide 305 while moving in the direction X2. When the image reading unit 301 irradiates the discriminating portion 306a or 306b with light, the image reading unit 301 receives the light reflected from the the discriminating portion 306a or 306b and outputs an electrical signal corresponding to the results of the reception of the light to the controller 130. Specifically, the image reading unit 301 reads a change in brightness of the light reflected from the discriminating portion 306a or 306b that is different according to the type of ADF 102 and outputs an electrical signal indicative of a read change in brightness as a result of reception of light to the controller 130.

The document base glass 302 is provided on the upper surface of the housing 300 as to be exposed to the outside. On the document base glass 302, the documents D are placed.

The flow reading glass 303 is a transparent plate-like member and is an example of a transparent member. The flow reading glass 303 is provided on the upper surface of the housing 300 as to be exposed to the outside. The flow reading glass 303 is provided adjacent to the the document base glass 302 in the moving direction of the image reading unit 301.

The guide shaft 304 supports the image reading unit 301 such that the image reading unit 301 is capable of moving in the directions X1 and X2 shown in FIG. 3.

The platen guide 305 as a guide member is opposed to the flow reading glass 303 and when the image reading unit 301 is moved to the image reading position, the platen guide 305 is opposed to the image reading unit 301 via the glow reading glass 303. The platen guide 305 guides the document D conveyed by the conveying roller pair 204d to the document reading position. In this embodiment, the document reading position is a position between the flow reading glass 303 and the platen guide 305. The platen guide 305 is provided with the discriminating portion 306a or 306b each of which has a different shape from that of the other according to the type of the ADF 102.

As shown in FIG. 4A, the discriminating portion 306a does not have a cut-out portion. In contrast, as shown in FIG. 4B, the discriminating portion 306b has a cut-out portion so that the shape of the discriminating portion 306b is different from that of the discriminating portion 306a. The type of the ADF 102 (first ADF) having the platen guide 305 provided with the discriminating portion 306a is different from that of the ADF 102 (second ADF) having the platen guide 305 provided with the discriminating portion 306b. For example, between the first ADF and the second ADF, the configuration of the image reading unit 205 and the conveying speed of the document are different from each other. The platen guides 305 in FIGS. 4A and 4B are the ones in FIG. 3 viewed from the side surface (left-right direction in FIG. 3).

The controller 130 controls the general operation of the image forming apparatus 100 based on the electrical signal input from the operation portion 120 and the image information input from the image reading unit 301.

The controller 130 identifies the type of the ADF 102 based on the results of light reception that is indicated by the electrical signal input from the image reading unit 301. Specifically, the controller 130 determines the type of the platen guide 305 and the ADF 102 based on a change in brightness indicated by the electrical signal input by the image reading unit 301. The controller 130 performs a control for determining that the combination of the ADF 102 and the document reading apparatus 103 conforms with the specification or not and for displaying the determination result to the operation portion 120.

The image reading apparatus 101 having the above described configuration reads an image on the document D through the fixed reading mode in which an image is read by scanning the document placed on the document base glass 302 or through the flow reading mode in which an image on the document D fed and conveyed by the ADF 102 is read.

In this embodiment, the image reading apparatus 101 is provided with the image reading unit 205. However, the configuration is not limited to this one and the image reading apparatus 101 may not be provided with the image reading unit 205.

### Operation of Image Reading Apparatus

The operation of the image reading apparatus 101 according to the first embodiment of the present disclosure will be described with reference to FIGS. 2 to 4.

First, the operation of the image reading apparatus 101 in the case where the image of a document D is read through the fixed reading mode will be described.

First, when the a document detection sensor (not shown) in the housing 300 detects that the document D is placed on the document base glass 302 of the document reading apparatus 103, the image reading apparatus 101 selects the fixed reading mode. In this case, the document detection sensor detects the presence/absence and the size of a document. Alternatively, the image reading apparatus 101 selects the fixed reading mode when a user designates the fixed reading mode by the operation portion 120 of the image forming apparatus 100.

When the document D should be placed on the document base glass 302, a user opens the ADF 102, places the document D on the document base glass 302, and then, closes the ADF 102. The document D placed on the document base glass 302 is positioned in a predetermined position of the document base glass 302 by the ADF 102 being closed.

When the fixed reading mode is selected, the image reading apparatus 101 reads the image on the document D placed on the document base glass 302 by irradiating the document D with light while moving the image reading unit 301 along the document base glass 302 by a driving motor (not shown). Then, the image reading apparatus 101 outputs image information of the read image to the controller 130.

Next, the operation of the image reading apparatus 101 in the case where the image on the document D is read through the flow reading mode.

First, when the document D placed on the document tray 200 of the ADF 102 is detected by the ADF 102 or when a user designates the flow reading mode by the operation portion 120 of the image forming apparatus 100, the image reading apparatus 101 selects the flow reading mode.

When the flow reading mode is selected, the image reading apparatus 101 moves the image reading unit 301 along the guide shaft 304 to the image reading position below the flow reading glass 303 by the driving motor (not shown).

Next, the image reading apparatus 101 separates and feeds the documents D placed on the document tray 200 one by one by the pick-up roller 202 and the separating roller 203.

Next, the image reading apparatus 101 conveys the document D fed by the pick-up roller 202 and the separating roller 203 to the image reading position by the conveying roller pairs 204a, 204b, 204c and 204d. Further, the image reading apparatus 101 guides the document D conveyed to the image reading position to the image reading position by the platen guide 305.

Next, the image reading apparatus 101 reads the image on the document D conveyed to the image reading position at the timing when the document D is conveyed to the image reading position by the image reading unit 301 that has been waiting in the image reading position.

Next, the image reading apparatus 101 conveys the documents D by the post conveying roller pairs 204e, 204f and 204g, and then, discharges the documents D onto the discharge tray 201, so that the documents D are stacked on the discharge tray 201.

When the ADF 102 is provided with the image reading unit 205 and the document reading apparatus 103 is provided with the image reading unit 301, an image on the top surface and the image on the back surface can be read at the same time only by conveying the document D once.

### ADF Identifying Operation

The ADF identifying operation of the image reading apparatus 101 according to the first embodiment of the present disclosure will be described in detail with reference to FIGS. 2 to 5B.

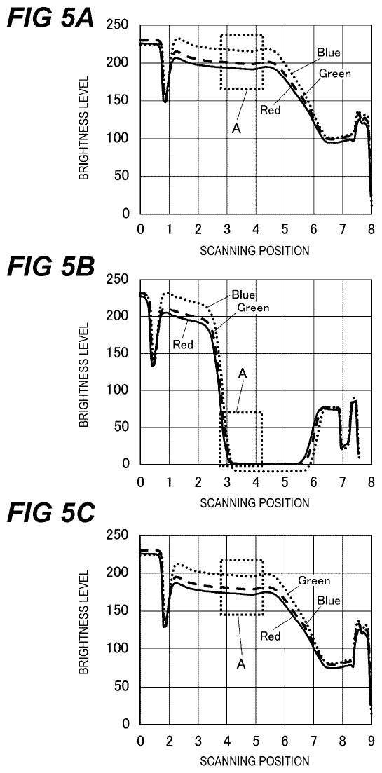

FIG. 5A shows a change in brightness of the discriminating portion 306a in the case where the the image reading unit 301 irradiates it with light. FIG. 5B shows a change in brightness of the discriminating portion 306b in the case where the the image reading unit 301 irradiates it with light.

The image reading apparatus 101 may solely perform the ADF identifying operation, or may perform it in parallel with other control operations such as a scanning operation for tint adjustment in the case where the main power of the image forming apparatus is turned on.

The image reading unit 301 irradiates the platen guide 305 with light while moving in the direction X2 in FIG. 3 (direction perpendicular to the figure surface of FIGS. 4A and 4B) in the state where the ADF 102 is installed on the document reading apparatus 103 and the document D is not conveyed. The image reading unit 301 receives the reflected light when the platen guide 305 is irradiated with light, photoelectrically converts the reflected light into an electrical signal, and outputs the electrical signal to the controller 130.

In this case, the image reading unit 301 reads a change in brightness according to the discriminating portion 306a or 306b of the platen guide 305, and outputs a signal indicating the read change in brightness to the controller 130. In this way, the image reading unit 301 irradiates the discriminating portion 306a or 306b with light and reads a change in brightness that is different in each type of the ADF 102, enabling the identification of the ADF 102.

Specifically, when the platen guide 305 is provided with the discriminating portion 306a that does not include a cut-out portion, the image reading unit 301 outputs a signal indicating a change in brightness in which high brightness is maintained in the region A in which a change in brightness of the discriminating portion 306a is indicated as shown in FIG. 5A. In contrast, when the platen guide 305 is provided with the discriminating portion 306b that includes a cut-out portion, the image reading unit 301 outputs a signal indicating a change in brightness in which brightness is lowered in the region A in which a change in brightness of the discriminating portion 306b is indicated as shown in FIG. 5B.

The controller 130 identifies the type of the ADF 102 by obtaining the average value of the brightness based on a change in brightness in a predetermined region of the signal input from the image reading unit 301 and by comparing the average value with the predetermined threshold value. For example, the controller 130 has a table stored in a memory (not shown) where the result of comparison of the average with the threshold value and the types of the ADF 102 are related and selects and judges the type of the ADF 102 related to the result of comparison referring to the table. Namely, the controller 130 identifies the type of the ADF 102 based on the result of the image reading unit 301 receiving the light reflected by the discriminating portion 306a or 306b of the platen guide 305. In other words, the controller 130 identifies the type of the ADF 102 based on the result of the image reading unit 301 reading a region including the discriminating portion 306a or 306b.

The controller 130 controls the operation of the image reading apparatus 101 such that the reading operation is performed in the sequence appropriate for the combination of the ADF 102 whose type has been identified and the document reading apparatus 103. For example, the controller 130 adjusts the amount of light with which the image reading unit 301 irradiates a document according to the type of the ADF 102.

When the combination of the ADF 102 whose type has been identified and the document reading apparatus 103 is out-of-specification, namely, not included in the specification in which assumed combinations of them are specified, the controller 130 displays the information to notify it to a user to avoid the unassumed combinations of the ADF 102 and the document reading apparatus 103 from being used. For example, a table is previously stored in a memory (not shown) which indicates the combination of ADF 102 and the document reading apparatus 103 determined by the specification. When the combination of the ADF 102 whose type has been identified and the document reading apparatus 103 does not exist or when the ADF 102 whose type has been identified does not exist in the table stored in the memory, the controller 130 judges as out-of-specification.

The color of the discriminating portions 306a and 306b of the platen guide 305 is preferred to be white in order that difference in brightness in case of a change of brightness between the discriminating portion 306a not having the cut-out portion and 306b having a cut-out portion becomes larger.

Further, when the apparatus main body 104 or the image reading apparatus 101 is provided with an LED as a notifying portion, the controller 130 may inform a user that the combination of the ADF 102 and the document reading apparatus 103 is out-of-specification by turning on or blinking the LED. In this way, the controller 130 may notify a user with the information that the combination of the ADF 102 and the document reading apparatus 103 is out-of-specification by light.

Further, when the apparatus main body 104 or the image reading apparatus 101 is provided with a speaker as a notifying portion, the controller 130 may inform a user that the combination of the ADF 102 and the document reading apparatus 103 is out-of-specification by the speaker. In this way, the controller 130 may warn a user with the information that the combination of the ADF 102 and the document reading apparatus 103 is out-of-specification by sound or voice.

Further, the controller 130 may notify a user with the information that the combination of the ADF 102 and the document reading apparatus 103 is out-of-specification by at least two of the display by the operation portion 120, sound or voice by the speaker and by light of the LED.

In this embodiment, the discriminating portion 306a or 306b is irradiated with light and the changes in brightness that are different from each other for type of the ADF 102 are read, so that the ADF 102 can be identified. As a result, the ADF 102 and the document reading apparatus 103 can be combined by identifying the ADF 102 without increasing the cost, so that an increase in a product cost can be suppressed.

### Second Embodiment

Since the configuration of the image forming apparatus according to the second embodiment of the present disclosure is the same as that shown in FIG. 1 and the description thereof will be omitted.

### Configuration of Image Reading Apparatus

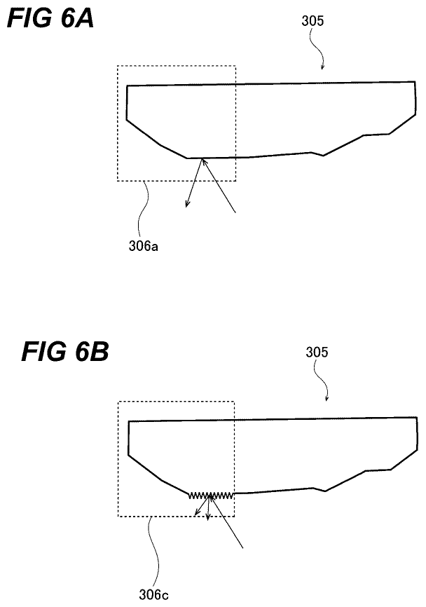

The configuration of the image reading apparatus according to the second embodiment of the present disclosure will be described in detail with reference to FIG. 6.

In FIG. 6 and the configuration of the image reading apparatus according to the present embodiment, the same reference characters are attached to the same portions as those in FIGS. 2 to 4 or the same portions as those in FIGS. 2 to 4 are not illustrated, and description thereof will be omitted. Further, the configuration other than the discrimination portions of the image reading apparatus according to the present embodiment will be described using the corresponding reference characters of image reading apparatus 101 according to the first embodiment.

FIG. 6A shows the platen guide 305 of the ADF 102 and FIG. 6B shows another platen guide 305 of an ADF 102 whose type is different from the that of the ADF 102 having the platen guide shown in FIG. 6A.

The platen guide 305 is provided with the discriminating portion 306a or the discriminating portion 306c whose diffusion levels for light are different from each other according to the type of the ADF 102.

The discriminating portion 306a does not have a minute uneven portion. In contrast, the discriminating portion 306c has a shape different from that of the discriminating portion 306a such that the discriminating portion 306c is provided with a minute uneven portion. The type of the ADF 102 having the platen guide 305 provided with the discriminating portion 306a is different from that of the ADF 102 having the platen guide 305 provided with the discriminating portion 306c.

The image reading unit 301 irradiates a predetermined region including the discriminating portion 306a or 306c of the platen guide 305 while moving in the direction X2 (direction from left to right in FIGS. 6A and 6B). When the image reading unit 301 irradiates the discriminating portion 306a or 306c with light, the image reading unit 301 receives the light reflected from the the discriminating portion 306a or 306c and outputs an electrical signal corresponding to the results of the reception of the light to the controller 130. Specifically, the image reading unit 301 reads a change in brightness of the light reflected from the discriminating portion 306a or 306c that is different according to the type of ADF 102 and outputs an electrical signal indicative of a read change in brightness as a result of reception of light to the controller 130.

The operation of the image reading apparatus according to the present embodiment is the same as that of the first embodiment and the description thereof will be omitted.

### ADF Identifying Operation

The ADF identifying operation of the image reading apparatus according to the second embodiment of the present disclosure will be described in detail with reference to FIGS. 5A, 5C, 6A and 6B.

FIG. 5C shows a change in brightness of the discriminating portion 306c in the case where the the image reading unit 301 irradiates it with light.

The image reading unit 301 irradiates the platen guide 305 with light while moving in the direction X2 in FIG. 3 in the state where the ADF 102 is installed on the document reading apparatus 103 and the document D is not conveyed. The image reading unit 301 receives the reflected light when the platen guide 305 is irradiated with light, photoelectrically converts the reflected light into an electrical signal, and outputs the electrical signal to the controller 130.

In this case, the image reading unit 301 reads a change in brightness according to the discriminating portion 306a or 306c of the platen guide 305, and outputs a signal indicating the read change in brightness to the controller 130. In this way, the image reading unit 301 irradiates the discriminating portion 306a or 306c with light and reads a change in brightness that is different in each type of the ADF 102, enabling the identification of the ADF 102.

Specifically, when the platen guide 305 is provided with the discriminating portion 306a that does not include a minute uneven portion, the image reading unit 301 outputs a signal indicating a change in brightness in which high brightness is maintained in the region A in which a change in brightness of the discriminating portion 306a is indicated as shown in FIG. 5A. In contrast, when irradiated with light, the discriminating portion 306c that includes a minute uneven portion has a light diffusion level larger than that of the discriminating portion 306a that does not include a minute uneven portion. Therefore, when the platen guide 305 is provided with the discriminating portion 306c that includes a minute uneven portion, the image reading unit 301 outputs a signal indicating a change in brightness in which brightness is lowered in the region A in which a change in brightness of the discriminating portion 306c is indicated as shown in FIG. 5C.

With this configuration, the ADF 102 having the platen guide 305 provided with the discriminating portion 306a and the ADF 102 having the platen guide 305 provided with the discriminating portion 306c are identified. The operations other than the above operations in the ADF identifying operations of the image reading apparatus according to the present embodiment are the same as those of the image reading apparatus 101 according to the first embodiment and the description thereof will be omitted.

In this embodiment, the discriminating portion 306a or 306c is irradiated with light and a change in brightness that is different from each other for type of the ADF 102 is read, so that the ADF 102 can be identified. As a result, the ADF 102 and the document reading apparatus 103 can be combined by identifying the ADF 102 without increasing the cost, so that an increase in a product cost can be suppressed.

The present disclosure is not limited to the above described embodiments and can be modified without departing from the gist.

Specifically, in the first embodiment and second embodiment, the discriminating portion 306b having a cut-out portion or the discriminating portion 306c having a minute uneven portion. However, the configuration is not limited to this one. A discriminating portion having a convex shape or discriminating portions having different colors may be provided according to the types of the ADF 102. Even in this case, the image reading unit 301 can output signals indicating different brightness changes according to the present/absence of a convex shape or colors.

In the first embodiment and second embodiment, the type of the ADF 102 is identified by the controller 130. However, the configuration is not limited to this one. Another controller for identifying the type of the ADF 102 may be provided in the image reading apparatus 101.

In the first embodiment and second embodiment, the configuration of the ADF 102 having platen guide 305 shown in FIG. 4A is the same as that of the ADF 102 having platen guide 305 shown in FIG. 4B except for the configuration of the platen guide 305. Accordingly, the fact that the controller 130 identifies the type of the ADF 102 means that the controller 130 also identifies the type of the platen guide 305. Namely, the controller 130 may identify the type of the ADF 102 as a whole or may identify the type of the platen guide 305 that is a part of the ADF 102. In this case, the controller 130 may notify only the fact that the type of the platen guide 305 is not appropriate.

According to the present disclosure, the type of the document feeder can be identified by the image reading apparatus.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-110380, filed Jul. 9, 2024, which is hereby incorporated by reference herein in its entirety.

What is claimed is:

1. An image reading apparatus comprising:
a document reading apparatus;
a document feeder; and
a controller,
wherein the document reading apparatus is provided with a transparent member and an image reading portion configured to read an image on a document conveyed by the document feeder via the transparent member,
wherein the document feeder is provided with a conveying roller configured to convey the document and a guide member configured to guide the document conveyed by the conveying roller, the guide member being opposed to the transparent member, wherein the guide member is provided with a discriminating portion corresponding to a type of the document feeder, and
wherein the controller identifies the type of the document feeder based on a result of the image reading portion reading a region including the discriminating portion of the guide member.

2. The image reading apparatus according to claim 1, further comprising a notifying portion configured to notify information indicating out-of-specification when the combination of the document feeder identified by the controller and the document reading apparatus is in the out-of-specification.

3. The image reading apparatus according to claim 2,
wherein the notifying portion is configured to notify the information indicating the out-of-specification by display.

4. The image reading apparatus according to claim 2,
wherein the notifying portion is configured to notify the information indicating the out-of-specification by sound or voice.

5. The image reading apparatus according to claim 2,
wherein the notifying portion is configured to notify the information indicating the out-of-specification by light.

6. The image reading apparatus according to claim 2,
wherein the notifying portion is configured to notify the information indicating the out-of-specification by at least two of display, sound or voice, and light.

7. The image reading apparatus according to claim 1,
wherein the controller identifies a type of the document feeder based on brightness obtained in a case where the image reading portion reads a region including the discriminating portion of the guide member.

8. The image reading apparatus according to claim 1,
wherein the discriminating portion has a different shape according to a type of the document feeder.

9. The image reading apparatus according to claim 1,
wherein the discriminating portion has a different color according to a type of the document feeder.

10. The image reading apparatus according to claim 1,
wherein the discriminating portion has a different light diffusion level according to a type of the document feeder.

11. An image reading apparatus comprising:
a document reading apparatus;
a document feeder; and
a controller,
wherein the document reading apparatus is provided with a transparent member and an image reading portion configured to read an image on a document conveyed by the document feeder via the transparent member,
wherein the document feeder is provided with a conveying roller configured to convey the document and a guide member configured to guide the document conveyed by the conveying roller, the guide member being opposed to the transparent member,
wherein the guide member is provided with a discriminating portion corresponding to a type of the document feeder, and
wherein the controller identifies a type of the guide member based on a result of the image reading portion reading a region including the discriminating portion of the guide member.

12. An image forming apparatus comprising:
the image reading apparatus according to claim 1; and
an image forming portion configured to form on a recording material an image on the document read by the image reading apparatus.
